(19) United States
(12) Patent Application Publication
(10) Pub. No.: US 2014/0083972 A1
(43) Pub. Date: Mar. 27, 2014

(54) PATTERN FORMING METHOD

(71) Applicant: Tokyo Electron Limited, Tokyo (JP)

(72) Inventors: Kenichi OYAMA, Nirasaki City (JP); Hidetami YAEGASHI, Tokyo (JP)

(73) Assignee: TOKYO ELECTRON LIMITED, Tokyo (JP)

(21) Appl. No.: 14/036,748

(22) Filed: Sep. 25, 2013

(30) Foreign Application Priority Data
Sep. 27, 2012 (JP) 2012-214854

(51) Int. Cl. H01B 13/00

(52) U.S. Cl. CPC H01B 13/003
USPC 216/13

(57) ABSTRACT

Provided is a pattern forming method which includes forming fine lines and spaces in a thin film on a substrate; forming a first pattern which is a reverse pattern of a trench pattern for forming wiring by cutting the lines; and forming a second pattern which will become the trench pattern by reversing the first pattern.

### CROSS-REFERENCE TO RELATED APPLICATION

This application claims the benefit of Japanese Patent Application No. 2012-214854, filed on Sep. 27, 2012, in the Japan Patent Office, the disclosure of which is incorporated herein in its entirety by reference.

### TECHNICAL FIELD

The present disclosure relates to a pattern forming method of forming a pattern in a semiconductor process.

### BACKGROUND

An exposure technique using extreme ultraviolet (EUV) with a very short wavelength of 13.5 nm has been proposed as a next-generation exposure technique in response to the miniaturization of a semiconductor device. However, the exposure technique is not applied to mass-production due to lack of the illumination intensity of a light source, and therefore, another approach is unavoidably employed.

Accordingly, a gridded design rule (GDR) using a one-dimensional layout is expected to be predominant by including logic. The GDR is based on a scheme for forming dense lines and spaces by means of self-aligned double patterning (SADP) based on 193 nm (ArF) and for cutting the lines or spaces. The SADP is a technique for obtaining a pitch, which is a half of a pitch formed through a lithography technique, by forming spacers on sidewalls of a first mask pattern, forming a second mask between the spacers, and removing the spacers.

Accordingly, it is possible to form lines and spaces of 16 nm node, but the fine lines and spaces of 16 nm node or lower requires a narrow pitch of grid lines. Therefore, multiple exposures of a cut mask are necessary for a narrow pitch in the cut mask. Self-aligned quadruple patterning (SAQP) can be applied to decrease the pitch of grid lines. The SAQP is a technique for obtaining a pitch, which is ¼ of that formed by means of through the lithography technique, by performing the patterning of the SADP twice.

In wiring GDR, lines and spaces are formed and a trench pattern is then formed by means of space cutting using a dot pattern.

In the wiring GDR, the spaces become Cu wiring, but the dimensional accuracy of the spaces is not sufficient in principle in case of the SADP or SAQP. Therefore, there is a problem in that the dimensional accuracy of the Cu wiring is lowered. In the wiring GDR, the dot pattern is formed upon the space cutting, but multiple exposures are needed to be performed in order to form a fine pattern by means of the SAQP. Hence, a new hard mask as a transfer layer is required, and therefore, the processes become redundant.

### SUMMARY

The present disclosure is conceived in consideration of such circumstances. Accordingly, an object of the present disclosure is to provide a pattern forming method in which high dimensional accuracy can be obtained when a fine pattern is formed by means of wiring GDR. Another object of the present disclosure is to provide a pattern forming method in which processes does not become redundant.

According to one embodiment of the present disclosure, there is provided a pattern forming method, which includes: forming fine lines and spaces in a thin film on a substrate; forming a first pattern which is a reverse pattern of a trench pattern for forming wiring by cutting the lines; and forming a second pattern as the trench pattern by reversing the first pattern.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 shows a flowchart illustrating a pattern forming method according to a first embodiment of the present disclosure and schematic plan views of respective processes.

FIG. 2 is a sectional view showing the structure of a device in which Process 1 is performed in the pattern forming method according to the first embodiment of the present disclosure.

FIG. 3 is a sectional view illustrating Process 1 in the pattern forming method according to the first embodiment of the present disclosure.

FIG. 4 is a sectional view illustrating Process 2 in the pattern forming method according to the first embodiment of the present disclosure.

FIG. 5 is a sectional view illustrating Process 2 in the pattern forming method according to the first embodiment of the present disclosure.

FIG. 6 is a sectional view illustrating Process 2 in the pattern forming method according to the first embodiment of the present disclosure.

FIG. 7 is a sectional view illustrating Process 2 in the pattern forming method according to the first embodiment of the present disclosure.

FIG. 8 is a sectional view illustrating Process 2 in the pattern forming method according to the first embodiment of the present disclosure.

FIG. 9 is a sectional view illustrating Process 3 in the pattern forming method according to the first embodiment of the present disclosure.

FIG. 10 is a sectional view illustrating Process 3 in the pattern forming method according to the first embodiment of the present disclosure.

FIG. 11 is a sectional view illustrating Process 4 in the pattern forming method according to the first embodiment of the present disclosure.

FIG. 12 is a perspective view showing a first pattern obtained in Process 4.

FIG. 13 is a sectional view illustrating Process 5 in the pattern forming method according to the first embodiment of the present disclosure.

FIG. 14 is a perspective view showing the state of FIG. 13.

FIG. 15 is a sectional view illustrating Process 5 in the pattern forming method according to the first embodiment of the present disclosure.

FIG. 16 is a perspective view showing the state of FIG. 15.

FIG. 17 is a sectional view illustrating Process 5 in the pattern forming method according to the first embodiment of the present disclosure.

FIG. 18 is a view showing a pattern width and a space width when SADP is performed in Process 2 of the pattern forming method according to the first embodiment of the present disclosure.

FIG. 19 is a view showing the shape of a space portion of a pattern obtained by a conventional pattern forming method.

FIG. 20 is a view showing the shape of a space portion of a pattern obtained by the pattern forming method according to the first embodiment of the present disclosure.

FIG. 21 is a flowchart illustrating a pattern forming method according to a second embodiment of the present disclosure.

FIG. 22 is a sectional view illustrating Process 11 in the pattern forming method according to the second embodiment of the present disclosure.

FIG. 23 is a sectional view illustrating Process 12 in the pattern forming method according to the second embodiment of the present disclosure.

FIG. 24 is a sectional view illustrating Process 12 in the pattern forming method according to the second embodiment of the present disclosure.

FIG. 25 is a sectional view illustrating Process 12 in the pattern forming method according to the second embodiment of the present disclosure.

FIG. 26 is a sectional view illustrating Process 12 in the pattern forming method according to the second embodiment of the present disclosure.

FIG. 27 is a sectional view illustrating Process 12 in the pattern forming method according to the second embodiment of the present disclosure.

FIG. 28 is a sectional view illustrating Process 12 in the pattern forming method according to the second embodiment of the present disclosure.

FIG. 29 is a sectional view illustrating Process 13 in the pattern forming method according to the second embodiment of the present disclosure.

FIG. 30 is a sectional view illustrating Process 14 in the pattern forming method according to the second embodiment of the present disclosure.

FIG. 31 is a sectional view illustrating Process 15 in the pattern forming method according to the second embodiment of the present disclosure.

FIG. 32 is a sectional view illustrating Process 16 in the pattern forming method according to the second embodiment of the present disclosure.

FIG. 33 is a sectional view illustrating Process 17 in the pattern forming method according to the second embodiment of the present disclosure.

FIG. 34 is a sectional view illustrating Process 17 in the pattern forming method according to the second embodiment of the present disclosure.

FIG. 35 is a sectional view illustrating Process 17 in the pattern forming method according to the second embodiment of the present disclosure.

FIG. 36 is a view showing a pattern width and a space width when SAQP is performed in Process 12 of the pattern forming method according to the second embodiment of the present disclosure.

### DETAILED DESCRIPTION

Embodiments of the present disclosure will now be described in detail with reference to the drawings. In the following detailed description, numerous specific details are set forth in order to provide a thorough understanding of the present invention(s). However, it will be apparent to one of ordinary skill in the art that the present invention(s) may be practiced without these specific details. In other instances, well-known methods, procedures, systems, and components have not been described in detail so as not to unnecessarily obscure aspects of the various embodiments.

### First Embodiment

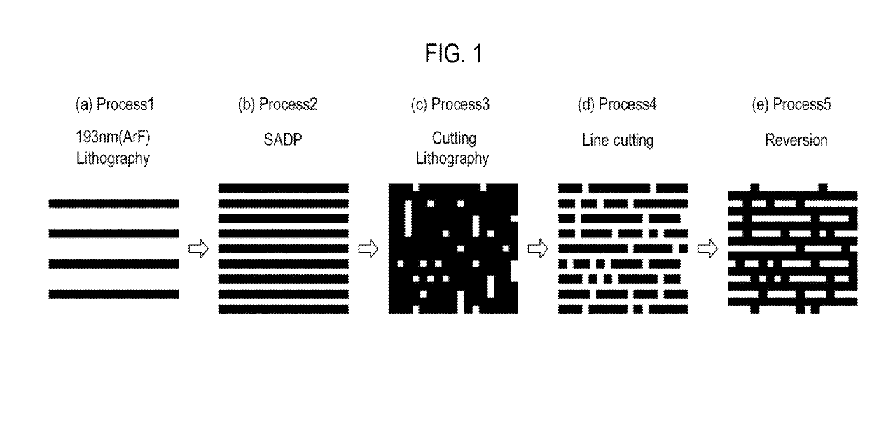

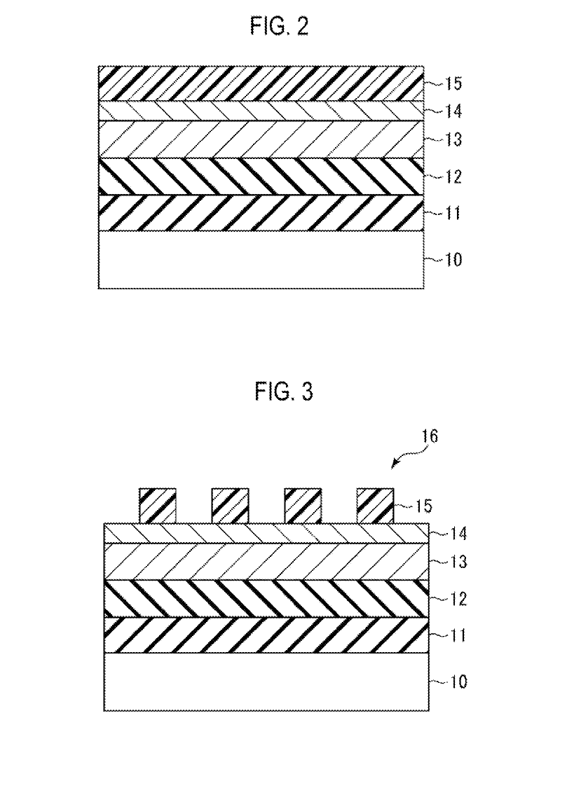

FIG. 1 shows a flowchart illustrating a pattern forming method according to a first embodiment of the present disclosure and schematic plan views of respective processes. FIGS. 2 to 17 are views illustrating the respective processes.

In this embodiment, as shown in FIG. 1 (a), a photoresist pattern composed of lines and spaces is first formed by means of photolithography using ArF having a wavelength of 193 nm as a light source (Process 1).

Specifically, as shown in FIG. 2, a pattern forming target film 11 that is formed of, for example, a low-k film; a thin film 12 for line cutting that is formed of, for example, a SiN film or SiO₂ film by a chemical vapor deposition (CVD); a spin-on-carbon (SOC) film 13; and an anti-reflection film 14 are sequentially formed on a semiconductor wafer 10 after a front end of line (FEOL) process (in which a structure of the semiconductor wafer formed through the FEOL process is omitted). Further, after a photoresist film 15 is formed, a photoresist pattern 16 in the shape of lines and spaces is formed by exposure and development using ArF having a wavelength of 193 nm, as shown in FIG. 3. In this case, a line width and a pitch are about 40 to 50 nm. The exposure used herein may be either an ordinary ArF exposure technique or ArF immersion exposure technique.

Then, as shown in FIG. 1 (b), a thin film pattern that is a line-and-space pattern having a line width and a pitch which are about a half of those of the photoresist pattern 16 is formed by means of SADP on the thin film 12 for line cutting (Process 2).

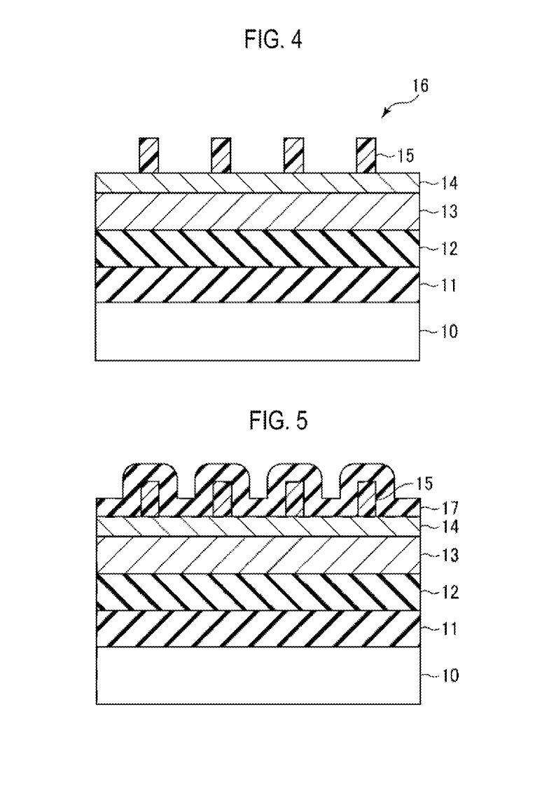

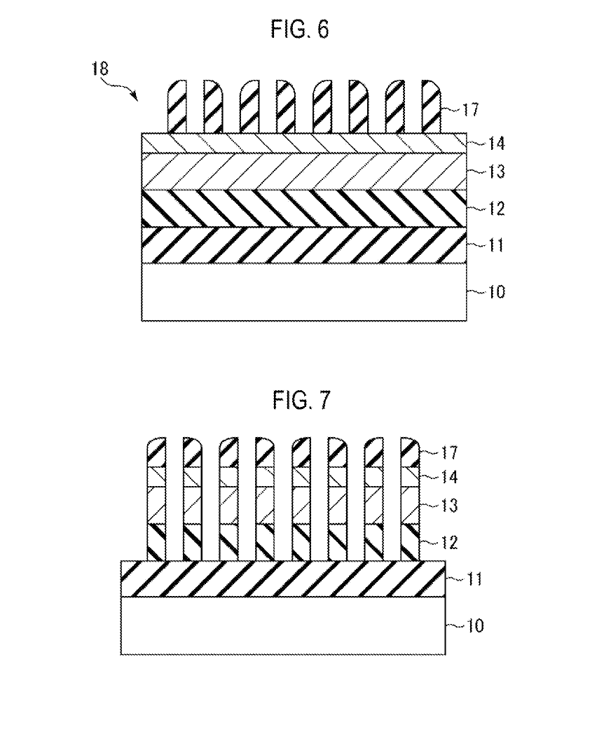

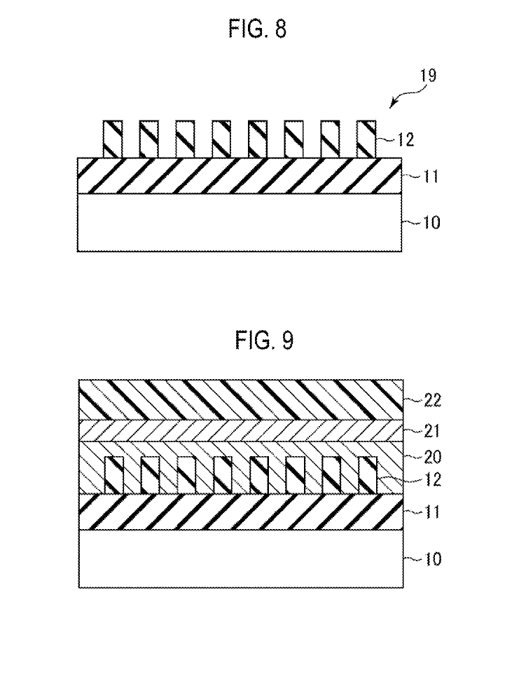

Specifically, from the state of FIG. 3, slimming of the photoresist pattern 16 is performed (FIG. 4). Then, a SiO₂ film 17 that will define spacers is formed on the photoresist pattern 16 (FIG. 5), and spacer etching is then performed by dry etching (anisotropic etching through reactive ion etching (RIE)), thereby forming a spacer pattern 18 (FIG. 6). Subsequently, the dry etching (anisotropic etching through RIE) is performed using the spacer pattern 18 as a mask as shown in FIG. 7, and the remaining SOC film 13, anti-reflection film 14 and SiO₂ film 17 are then removed as shown in FIG. 8, thereby forming a thin film pattern 19 as a line-and-space pattern having a pitch which is about a half of the pitch of the photoresist pattern 16 on the thin film 12 for line cutting.

Thereafter, as shown in FIG. 1 (c), a photoresist pattern for obtaining a line-cutting pattern that is an inverse pattern of a trench pattern for forming Cu wiring is formed by means of photolithography using ArF having a wavelength of 193 nm (Process 3).

Specifically, as shown in FIG. 9, a protective film 20 made of, for example, SOC for protecting the thin film pattern 19 is formed on the thin film 12 for line cutting with the thin film pattern 19 formed therein, and an anti-reflection film 21 and a photoresist film 22 are then formed. Subsequently, as shown in FIG. 10, a photoresist pattern 23 that will become a line-cutting pattern which is an inverse pattern of a trench pattern for forming Cu wiring is formed by exposure and development using ArF of a wavelength of 193 nm.

As shown in FIG. 1 (d), line cutting is then performed on the thin film pattern 19 by using the photoresist pattern 23, and a first pattern that is an inverse pattern of a trench pattern for forming Cu wiring is formed (Process 4).

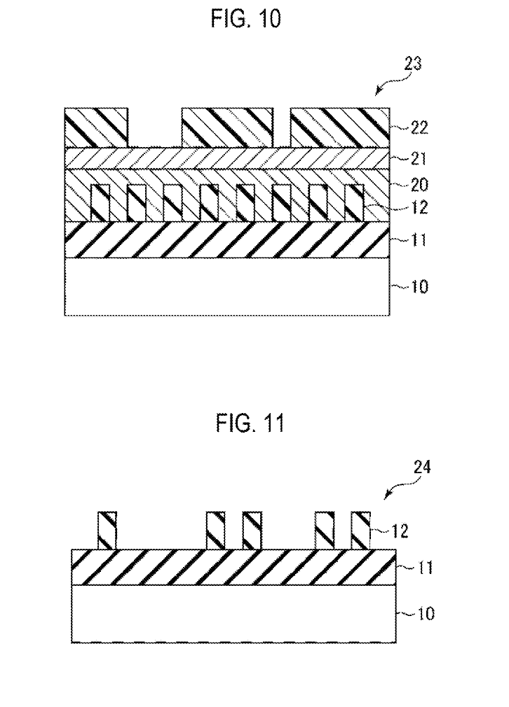

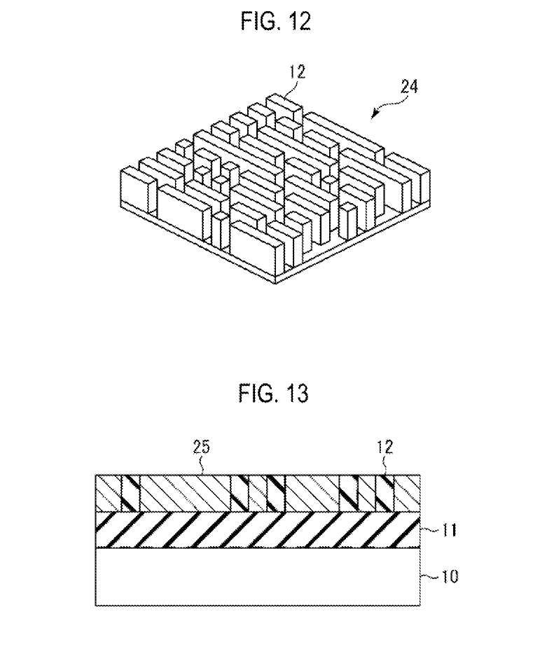

Specifically, as shown in FIG. 11, line-cutting etching is performed on the thin film pattern 19 by dry etching (anisotropic etching through RIE) using the photoresist pattern 23 as a mask, and the remaining protective film 20, anti-reflection film 21 and photoresist film 22 are then removed. Accordingly, as also shown in the perspective view of FIG. 12, the first pattern 24 that is an inverse pattern of a trench pattern for forming Cu wiring is formed on the thin film 12 for line cutting.

As shown in FIG. 1 (e), a second pattern that will become a trench pattern for forming Cu wiring is then formed by reversing the first pattern 24 (Process 5).

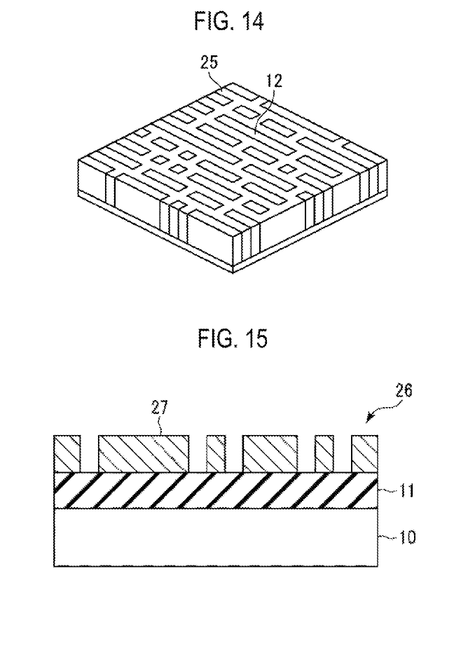

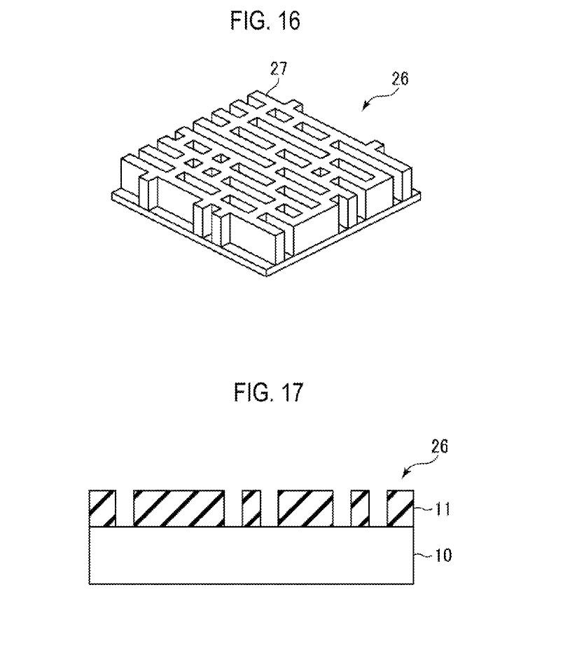

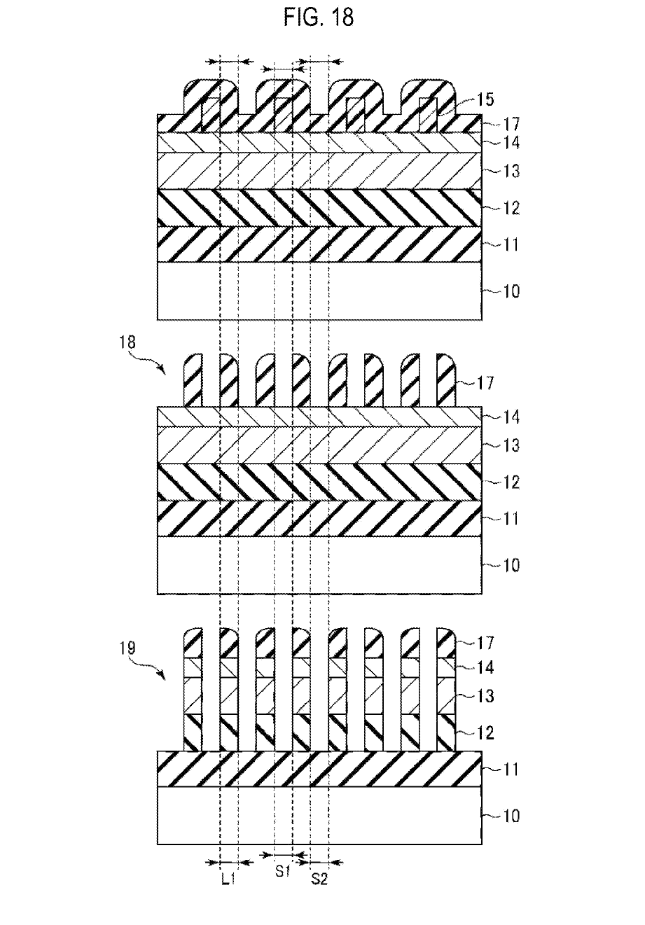

Specifically, a reverse film 25 made of, for example, an amorphous carbon film or Si film is formed to fill spaces in the thin film 12 for line cutting that has been formed with the first pattern 24 shown in FIGS. 11 and 12 (FIGS. 13 and 14); and the thin film 12 for line cutting in the first pattern 24 is then removed by wet etching or the like. As shown in FIGS. 15 and 16, the remaining reverse film 25 is used as a hard mask film 27 for the second pattern 26 that is an inverse pattern of the first pattern 24. As shown in FIG. 17, the second pattern 26 is formed on the pattern forming target film 11 by means of dry etching (anisotropic etching through RIE) using the hard mask film 27 as a mask, and the hard mask film 27 is then removed. Accordingly, it is possible to form a fine pattern to about 20 nm.

The second pattern 26 becomes a trench pattern for forming Cu wiring, and the pattern forming target film 11 functions as an interlayer insulating film.

Alternatively, without forming the pattern forming target film 11, a low-k film or the like is used as the reverse film 25 to be embedded in the first pattern 24 of the thin film 12 for line cutting, and the thin film 12 for line cutting in the first pattern 24 is then removed, so that the reverse film 25 in the second pattern 26 may be directly used as the interlayer insulating film.

As described above, in a case where metal wiring such as Cu wiring or the like is formed by means of GDR, according to a conventional method, lines and spaces are formed in a thin film by means of SADP and a trench pattern is then formed by performing space cutting using a dot pattern. However, in case of SADP, the dimensional accuracy of space portions is lower than that of line portions in principle. Therefore, if the spaces formed by SADP are used as trenches, there may be a concern that the dimensional accuracy may be insufficient.

This will be described below in detail.

As shown in FIG. 18, according to SADP, the SiO₂ film 17 is formed on the photoresist pattern 16 after the slimming, and the spacer etching is then performed to form the spacer pattern 18. Subsequently, the dry etching is performed using the spacer pattern 18 as a mask, and the thin film pattern 19 that is a line-and-space pattern having a pitch which is a half of that of the photoresist pattern 16 is formed on the thin film 12 for line cutting. All of the widths of the lines are L1, which is identical to the width of the spacer, whereas the widths of the spaces are two kinds of widths, i.e., a width S1 corresponding to the width of the photoresist pattern 16 after the slimming and a width S2 between spacer portions adjacent without the photoresist pattern 16 when the SiO₂ film 17 has been formed. Therefore, the dimensional accuracy of the width of the space is unavoidably lowered.

Thus, in this embodiment, the first pattern that is an inverse pattern of a trench pattern for forming Cu wiring is formed by performing the line cutting on the line-and-space pattern formed by means of SADP, and the second pattern that will become a trench pattern for forming Cu wiring is formed by reversing the first pattern. Accordingly, since the width of a trench that will become Cu wiring is L1 that is the width of a line in case of SADP, it is possible to increase the dimensional accuracy of Cu wiring over a conventional method in which space portions having two kinds of widths, i.e., S1 and S2, resulting from space cutting in the line-and-space pattern without reversing the first pattern are used as trenches that will become Cu wiring.

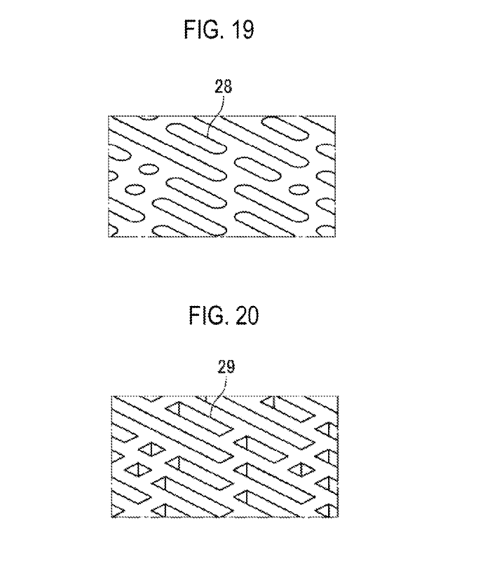

In a case where space cutting is performed on a line-and-space pattern as in a conventional method so that space portions are used as trenches in which Cu wiring is formed, an end portion of a space portion 28 that will become Cu wiring is rounded as shown in FIG. 19. However, in case of this embodiment, a space portion 29 that will become Cu wiring is formed as a line portion of the first pattern 24 is reversed, as shown in FIG. 20, so that the end portion of the space portion 29 can be finished in a completely rectangular pattern.

When the line cutting is performed, its process can be simplified as compared with that of the space cutting.

### Second Embodiment

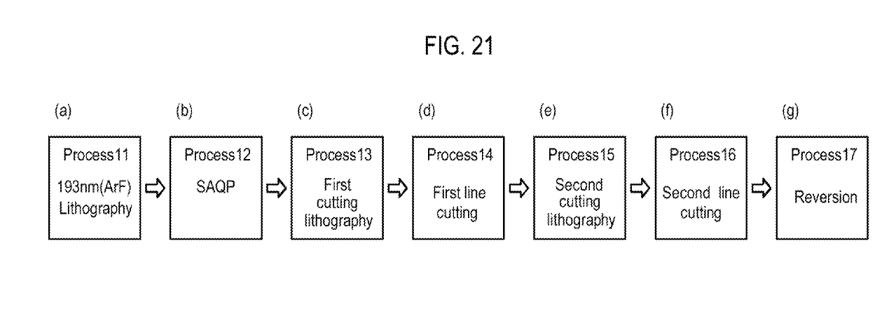

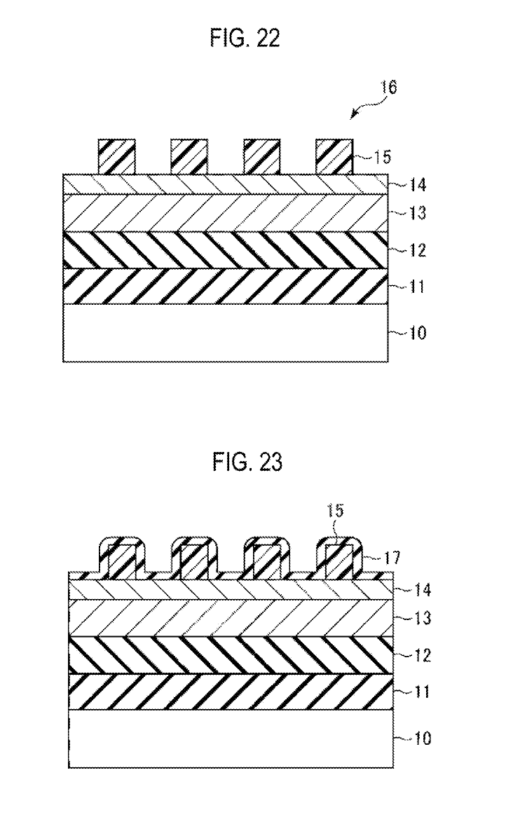

FIG. 21 is a flowchart illustrating processes of a pattern forming method according to a second embodiment of the present disclosure. FIGS. 22 to 35 are views illustrating the respective processes.

In this embodiment, a finer pattern than the pattern of the first embodiment is formed by using SAQP. Although the number of processes is increased, basic processes are identical to those of the first embodiment, and thus only the main portions will be described.

In this embodiment, similar to the first embodiment, a photoresist pattern composed of lines and spaces is first formed by photolithography using ArF having a wavelength of 193 nm, as shown in FIG. 21 (a) (Process 11).

Specifically, as shown in FIG. 22 and similar to the first embodiment, a pattern forming target film 11, a thin film 12 for line cutting, a spin-on-carbon (SOC) film 13, and an anti-reflection film 14 are sequentially formed on a semiconductor wafer 10 after a front end of line (FEOL) process (wherein a structure of the semiconductor wafer formed through the FEOL process is omitted). Further, after a photoresist film 15 is formed, a photoresist pattern 16 in the shape of lines and spaces is formed by exposure and development using ArF having a wavelength of 193 nm. In this case, a line width and a pitch are about 40 to 50 nm. The exposure used herein may be either an ordinary ArF exposure technique or ArF immersion exposure technique.

As shown in FIG. 21 (b), a thin film pattern that is a line-and-space pattern having a line width and a pitch which are about ¼ of those of the photoresist pattern 16 is then formed by means of SAQP on the thin film 12 for line cutting (Process 12).

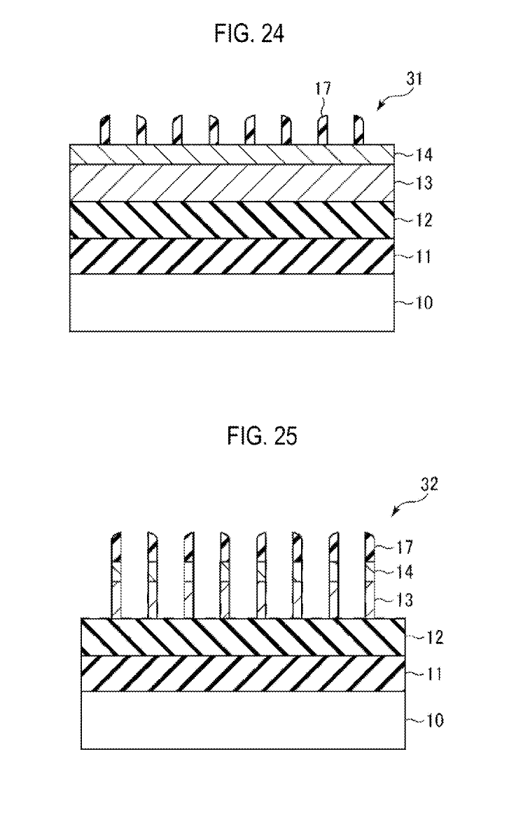

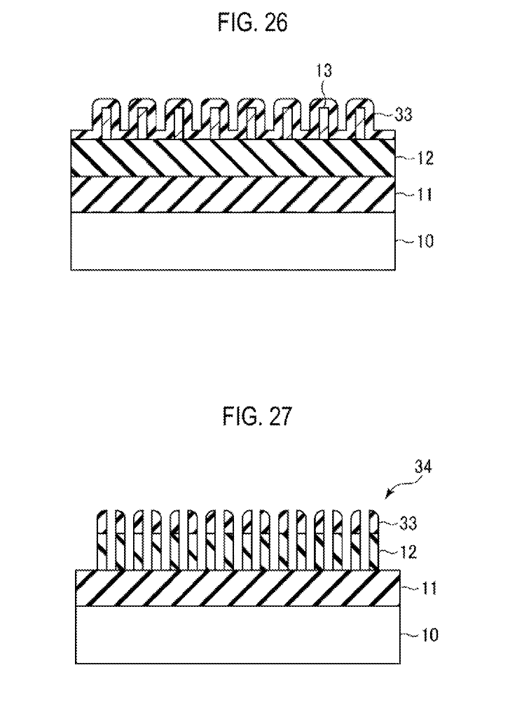

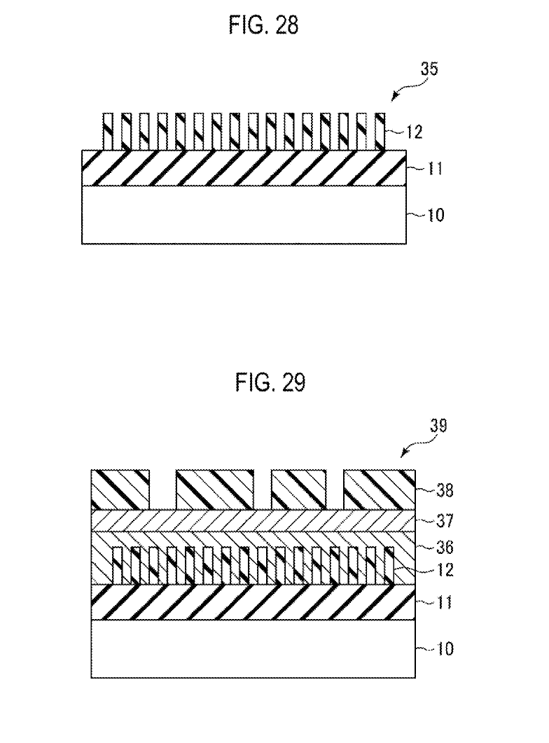

Specifically, from the state of FIG. 22, slimming of the photoresist pattern 16 is performed. Then, a SiO₂ film 17 that will define spacers is formed on the photoresist pattern 16 so as to be thinner than that of the first embodiment (FIG. 23). Spacer etching is then performed by dry etching (anisotropic etching through RIE), thereby forming a spacer pattern 31 (FIG. 24). Subsequently, the dry etching (anisotropic etching through RIE) is performed using the spacer pattern 31 as a mask as shown in FIG. 25 and a thin film pattern 32 is formed on the SOC film 13. The remaining anti-reflection film 14 and SiO₂ film 17 are then removed as shown in FIG. 26, whereby a SiO₂ film 33 that will become a spacer is again formed on the SOC film 13 with the thin film pattern 32 formed therein. Subsequently, as shown in FIG. 27, spacer etching is performed by dry etching (anisotropic etching through RIE), thereby forming a spacer pattern 34, and the dry etching (anisotropic etching through RIE) is performed on the thin film 12 for line cutting by using the spacer pattern 34 as a mask. As shown in FIG. 28, the remaining SiO₂ film 33 is removed, thereby forming a thin film pattern 35 that is as a line-and-space pattern having a pitch which is about ¼ of that of the photoresist pattern 16 on the thin film 12 for line cutting.

As shown in FIG. 21 (c), a first photoresist pattern for use in obtaining a line-cutting pattern that is an inverse pattern of a trench pattern for forming Cu wiring is then formed by means of photolithography using ArF having a wavelength of 193 nm (Process 13).

Specifically, as shown in FIG. 29 and similar to Process 3 of the first embodiment, a protective film 36 made of, for example, SOC is formed on the thin film 12 for line cutting with the thin film pattern 35 formed therein, and an anti-reflection film 37 and a photoresist film 38 are then formed. A photoresist pattern 39 for a first line-cutting pattern is then formed by exposure and development using ArF of a wavelength of 193 nm.

Continuously, as shown in FIG. 21 (d), first line cutting is performed on the thin film pattern 35 by using the photoresist pattern 39 (Process 14).

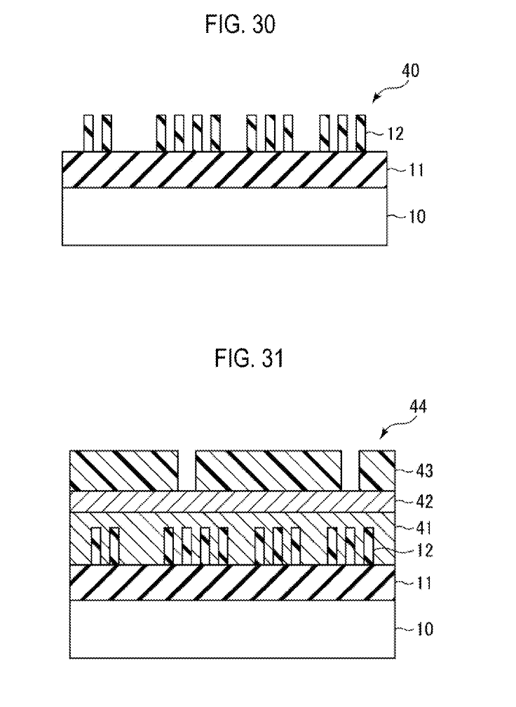

Specifically, as shown in FIG. 30, line-cutting etching is performed on the thin film pattern 35 by dry etching (anisotropic etching through RIE) using the photoresist pattern 39 as a mask, and the continuously remaining protective film 36, anti-reflection film 37 and photoresist film 38 are removed, thereby forming a first line-cutting pattern 40.

As shown in FIG. 21 (e), a second photoresist pattern for obtaining a line-cutting pattern that is an inverse pattern of a trench pattern for forming Cu wiring is then formed by photolithography using ArF having a wavelength of 193 nm (Process 15).

Since in this embodiment, a finer pattern than the pattern of the first embodiment is formed, a desired pattern is not obtained through the use of the first line cutting alone.

Accordingly, the second line cutting is performed. In Process 15, photolithography is performed to form a second pattern.

Specifically, as shown in FIG. 31, a protective film 41 is formed on the thin film 12 for line cutting with the first line-cutting pattern 40 formed therein, and an anti-reflection film 42 and a photoresist film 43 are then formed. A photoresist pattern 44 for a second line-cutting pattern is then formed by exposure and development using ArF having a wavelength of 193 nm.

Subsequently, as shown in FIG. 21 (f), second line cutting is performed by using the photoresist pattern 44, and a first pattern that is an inverse pattern of a trench pattern for forming Cu wiring is formed (Process 16).

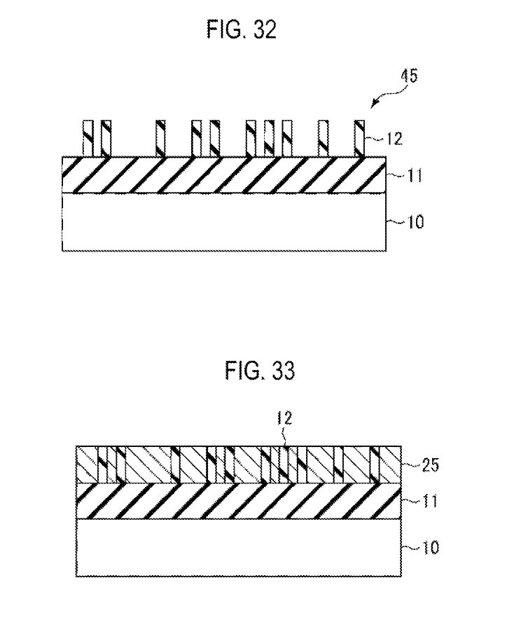

Specifically, as shown in FIG. 32, second line cutting is performed on the thin film 12 for line cutting by dry etching (anisotropic etching through RIE) using the photoresist pattern 44 as a mask, and the remaining protective film 41, anti-reflection film 42 and photoresist film 43 are removed. Accordingly, a first pattern 45 that is an inverse pattern of a trench pattern for forming Cu wiring is formed on the thin film 12 for line cutting.

AS shown in FIG. 21 (g), a second pattern that will become a trench pattern for forming Cu wiring is then formed by reversing the first pattern 45 (Process 17).

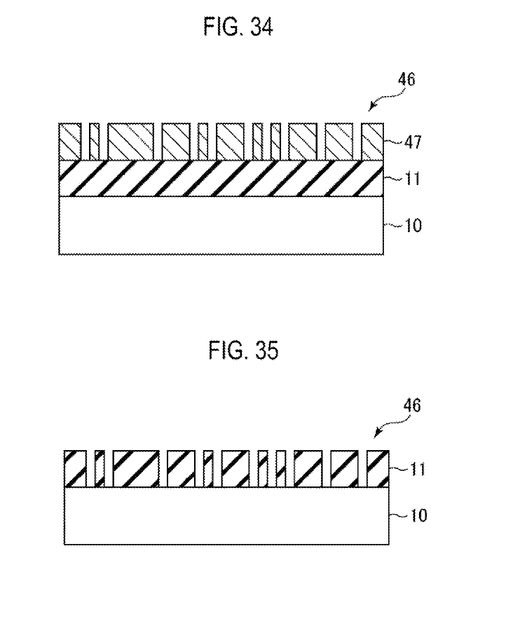

Specifically, a reverse film 25 made of, for example, an amorphous carbon film or Si film is formed to fill spaces in the thin film 12 for line cutting in the first pattern 45 shown in FIG. 32 (FIG. 33); and the thin film 12 for line cutting in the first pattern 45 is then removed by wet etching or the like. As shown in FIG. 34, the remaining reverse film 25 is used as a hard mask film 47 for the second pattern 46 that is an inverse pattern of the first pattern 45. As shown in FIG. 35, the second pattern 46 is formed on the pattern forming target film 11 by means of dry etching (anisotropic etching through RIE) using the hard mask film 47 as a mask, and then, the hard mask film 47 is removed. Accordingly, it is possible to form an ultra fine pattern to about 10 nm.

The second pattern 46 becomes a trench pattern for forming Cu wiring, and the pattern forming target film 11 functions as an interlayer insulating film.

Alternatively, even in this embodiment, similar to the first embodiment, the pattern forming target film 11 is not formed, a low-k film or the like is used as the reverse film 25 to be embedded in the first pattern 45 of the thin film 12 for line cutting, and the thin film 12 for line cutting in the first pattern 45 is then removed, so that the reverse film 25 in the second pattern 46 may be used as the interlayer insulating film.

In a case where metal wiring such as Cu wiring or the like is made by forming a trench pattern by means of space cutting using a dot pattern as in a conventional method after an ultrafine line-and-space pattern is formed by SAQP, there may be a concern that the dimensional accuracy may be more insufficient than that of the first embodiment.

This will be described below in detail.

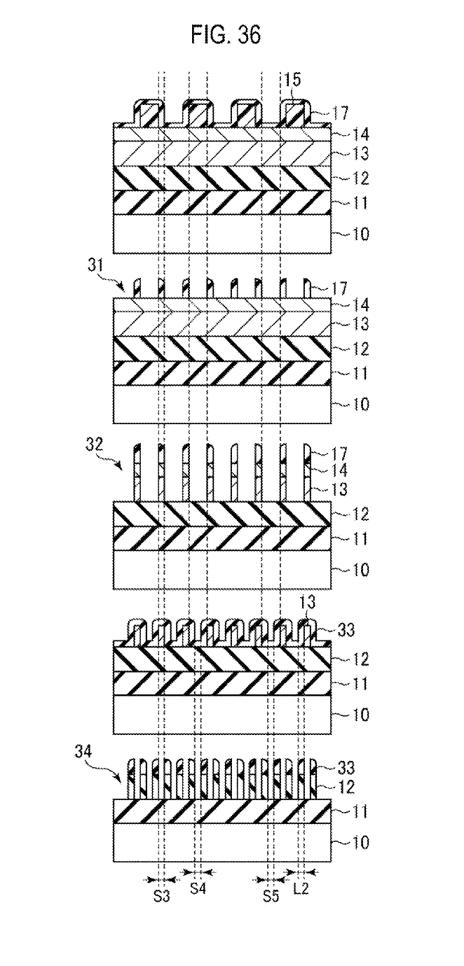

As shown in FIG. 36, according to SAQP, the SiO₂ film 17 is formed on the photoresist pattern 16 after the slimming, and the spacer etching is then performed to form the spacer pattern 31. Subsequently, the dry etching is performed using the spacer pattern 31 as a mask, and the thin film pattern is formed on the SOC film 13. Then, the remaining anti-reflection film 14 and SiO₂ film 17 are removed, and the SiO₂ film 33 that will become spacers is formed again on the SOC film 13 with the thin film pattern 32 formed therein. The spacer pattern 34 is then formed by spacer etching, and the thin film pattern 35 that is a line-and-space pattern having a pitch which is ¼ of that of the photoresist pattern 16 is formed on the thin film 12 for line cutting by using the spacer pattern 34 as a mask. At this time, all the widths of the lines are L2 identical to those of the spacer of the SiO₂ film 33, whereas the widths of the spaces are three kinds of widths, i.e., a width S3 corresponding to that of the spacer of the initial SiO₂ film 17, a width S4 based on that of the slimmed photoresist pattern 16, and a width S5 based on that between spacers of the SiO₂ film 17 adjacent without the photoresist pattern 16. Therefore, the dimensional accuracy of the width of the space is unavoidably lowered.

Thus, even in this embodiment, similar to the first embodiment, the first pattern that is an inverse pattern of a trench pattern for forming Cu wiring is formed by performing the line cutting on the line-and-space pattern, and the second pattern that will become a trench pattern for forming Cu wiring is formed by reversing the first pattern. Accordingly, since the width of a trench that will become Cu wiring is L2 that is the width of a line in case of SAQP, it is possible to remarkably increase the dimensional accuracy of Cu wiring over a conventional method in which space portions having three kinds of widths, i.e., S3, S4 and S5, resulting from space cutting in the line-and-space pattern without reversing the first pattern are used as trenches that will become Cu wiring.

Moreover, in a case where metal wiring such as Cu wiring or the like is made by forming a trench pattern by means of space cutting as in a conventional method after an ultrafine line-and-space pattern is formed by SAQP, it is necessary to perform the space cutting twice. In this case, the space cutting is based on multiple exposure using a dot pattern, but a new hard mask that is a transfer layer is needed to be added in order to perform the space cutting twice, resulting in redundant processes. In this regard, as in this embodiment, employing the method in which the line-and-space pattern is formed by SAQP, the line cutting is then performed twice and the pattern is reversed can shorten the processes as compared with a conventional method, thereby avoiding the redundancy of the processes.

The present disclosure is not limited to the embodiments, but may be variously modified. For example, the structure of a device and the material of each film in the embodiments are only illustrative and different variations thereof may be used based on the principle of the present disclosure. In addition, the pattern reversion is not necessarily performed on all of the patterns. For example, in a case where it is not necessary to reverse even a peripheral circuit, the pattern reversion may be performed only within a cell.

According to the present disclosure, a first pattern that is an inverse pattern of a trench pattern for forming wiring is formed by forming fine lines and spaces in a thin film on a substrate and performing line cutting and a second pattern that will become a trench pattern is formed by reversing the first pattern, so that a line having high dimensional accuracy among the fine lines and spaces formed on the thin film on the substrate can be used as the trench for forming the wiring, resulting in high dimensional accuracy.

Further, after the fine lines and spaces are formed in the thin film, the first pattern that is an inverse pattern of the trench pattern for forming the wiring is formed by performing line cutting, thereby shortening the processes as compared with space cutting.

While certain embodiments have been described, these embodiments have been presented by way of example only, and are not intended to limit the scope of the disclosures. Indeed, the novel methods and apparatuses described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A pattern forming method, comprising:
forming fine lines and spaces in a thin film on a substrate;
forming a first pattern which is a reverse pattern of a trench pattern for forming wiring by cutting the lines; and
forming a second pattern as the trench pattern by reversing the first pattern.

2. The pattern forming method of claim 1, wherein the forming the fine lines and spaces comprises forming a photoresist pattern in a shape of lines and spaces in a photoresist film on a thin film by means of photolithography using ArF as a light source, and then forming lines and spaces finer than those of the photoresist pattern in the thin film by self-aligned double patterning (SADP).

3. The pattern forming method of claim 2, wherein the forming the first pattern comprises forming a photoresist pattern for forming the first pattern by means of photolithography, and then performing line-cutting etching on the fine lines and spaces by using the photoresist pattern as a mask.

4. The pattern forming method of claim 1, wherein the forming the fine lines and spaces comprises forming a photoresist pattern in a shape of lines and spaces in a photoresist film on a thin film by means of photolithography using ArF as a light source, and then forming lines and spaces finer than those of the photoresist pattern in the thin film by self-aligned quadruple patterning (SAQP).

5. The pattern forming method of claim 4, wherein the forming the first pattern comprises:
forming a first photoresist pattern by means of first photolithography and then performing first line-cutting etching on the fine lines and spaces by using the photoresist pattern as a mask so as to form a first line-cutting pattern; and
forming a second photoresist pattern by means of second photolithography and then performing second line-cutting etching on the fine lines and spaces by using the photoresist pattern as a mask so as to form the first pattern.

6. The pattern forming method of claims 1, wherein the forming the second pattern by reversing the first pattern comprises forming a reverse film to be filled in the spaces of the thin film of the first pattern, continuously removing the thin film of the first pattern, and then forming the second pattern by the remaining reverse film.

7. The pattern forming method of claim 6, wherein the reverse film with the second pattern is used as a hard mask to etch a pattern forming target film beneath the reverse film, thereby forming the second pattern in the pattern forming target film, and
wherein the second pattern is used as a trench pattern for forming wiring.

8. The pattern forming method of claim 6, wherein the reverse film of the second pattern is used as a trench pattern for forming wiring.
